(19) United States
(12) Patent Application Publication
(10) Pub. No.: US 2004/0190469 A1
(43) Pub. Date: Sep. 30, 2004

(54) Wireless data communications

(75) Inventors: Johanna Pekonen, Espoo (FI); Rami Vaittinen, Littoinen (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/641,035

(22) Filed: Aug. 15, 2003

(30) Foreign Application Priority Data
Mar. 28, 2003 (GB) 0307266.7

(51) Int. Cl. H04Q 7/00

(52) U.S. Cl. 370/328

(57) ABSTRACT

A method usually for notifying a station of a wireless data transmission session in a communication system is disclosed. The data transmission session is typically receivable by a plurality of stations, usually located within a service area defined in the communication system. The method includes sending on at least one broadcasting channel notifications regarding the wireless data transmission session. A communication system for embodying the method and a message for carrying the required information is also described.

### BACKGROUND OF THE INVENTION

1. Field of the Invention

The present specification relates generally to wireless data communications and, more particularly, to transmission of notifications regarding wireless data communication sessions in a communication system.

2. Description of the Related Art

A communication system may be seen as a facility that enables communication between two or more entities, such as, but not limited to, user equipment, elements of a communication network and other entities associated with the communication system. A communication system typically operates in accordance with a given standard and/or specification which usually sets out what the various entities associated with the communication system are permitted to do and how that should be achieved. For example, the standard and/or specification may define if the user, or more precisely, user equipment or terminal, is provided with a circuit switched service and/or a packet switched service. Communication protocols and/or parameters which may be used for the connection may also be defined. In other words, a specific set of “rules” are provided upon which the communication may be based, depending on needs to be defined to enable communication by means of the system.

Communication systems providing wireless communication for the user equipment are generally known to those skilled in the art. An example of a wireless systems is a cellular network. In cellular network systems, a base transceiver station (BTS), or similar access entity, typically serves mobile stations (MS) and/or other such wireless user equipment (UE), usually via a wireless interface between these entities. The communication between the mobile stations and the elements of the communication network may be based, for example, on an appropriate communication protocol. The operation of the base station apparatus and other apparatus commonly required for the communication may be controlled by one or several control entities. The various control entities may be interconnected. One or more gateway nodes may also be provided for connecting the cellular network to other networks. The other networks may include, for example, another mobile network, a public switched telephone network (PSTN) and/or other communication networks such as, but not limited to, an IP (Internet Protocol) and/or other packet switched networks.

An example of the services that may be offered for the subscribers to a communication system is the so-called multimedia services. An example of communication systems enabled to offer the multimedia services for the users are IP (Internet Protocol) Multimedia networks. IP Multimedia (IM) functionalities may be provided by means of an IP Multimedia subsystem (IMS). The data to be communicated in the multimedia application may include various types of data. For example, voice, video or other image data, streaming data, text data and/or other content data may be communicated via a communication system.

An example of a multimedia application is the so-called multimedia broadcasting multicasting service (MBMS). The MBMS may be described as a multimedia service that is usually arranged to transmit MBMS data to users that have requested the service by means of point-to-point (P-t-P) or/and point-to-multipoint (P-t-M) connections. The multimedia broadcasting multicasting services may be divided in two modes, for example, into a broadcast mode and multicast mode.

In accordance with the currently-available MBMS broadcast mode, the mobile station may be able to receive MBMS data without any request for the service. The broadcast mode is normally a unidirectional point-to-multipoint transmission of multimedia data from a single source entity to all users in a broadcast service area. The broadcast mode may use radio/network resources for transmission of data over a common radio channel.

In the typical MBMS multicast mode, the mobile station may request for the service by, for example, processing a joining procedure before being able to receive MBMS data of that particular MBMS service. The user may also need to have a multicast subscription before being able to join a multicast group. For example, 3GPP (3^{rd} Generation Partnership Project) specification TS 22.146, section 3.1, submits that a multicast subscription process by which a user subscribes or is subscribed to a multicast subscription group is generally required for authorizing the user to join certain multicast services.

The MBMS multicast mode also normally allows the unidirectional point-to-multipoint transmission of multimedia data. The data is usually transmitted from a single source point to a multicast group in a multicast service area. As with the broadcast mode, data may be transmitted via radio/network resources over a common radio channel. The multicast mode commonly provides the possibility for selective transmission to cells within the multicast service area. The selected cells typically contain members of a multicast group. A multicast service received by a user equipment may involve one or more successive multicast sessions. A multicast service may, for example, include a single on-going session such as, but not limited to, a multimedia stream. The multicast service may also involve several intermittent multicast sessions, usually over an extended period of time, for example, messages to users.

A typical difference between the two MBMS modes is that, in the broadcast mode, all users within the service area are normally targeted whereas, in the multicast mode, it is usually possible to limit the number of the target users, for example, to a predefined subset of users in the service area. Furthermore, the modes generally differ in that, in the broadcast mode, there is normally no specific requirement to activate and/or subscribe to the MBMS.

A user commonly has to join a MBMS multicast mode in order to receive the service. Joining may be defined as the process by which a user joins, in other words, becomes a member of a multicast group. By joining, the user usually indicates to the network that he/she is willing to receive Multicast mode data of a specific service. The term ‘joining’ may thus be understood as an activation of a MBMS multicast mode.

The session may be defined as a continuous and/or time-bounded reception of a broadcast or multicast service by user equipment such as, but not limited to, a mobile station. A single broadcast or multicast service usually can only have one session at any time. A broadcast or multicast service may include multiple successive broadcast or multicast sessions. In this application, the phrase ‘MBMS data session’ is generally intended to cover both Broadcast sessions and Multicast sessions, unless otherwise mentioned.

The inventors have identified some problems in the related art regarding multimedia sessions. In the following, some of the identified problems of the Multimedia Broadcast Multicast Service (MBMS) will be described, with reference to the GSM EDGE Radio Access Networks (GERAN).

In most circumstances, before a data transmission session can start, the network usually needs to indicate to each of the users subscribed to the service about the start of the data transmission. A common problem is associated with how to inform the mobile station that a MBMS data session is to be started or is active when no air interface is activated for the MBMS data transmission for the mobile station. More specifically, for example, a problem may arise when an indication needs to be given to mobile stations regarding the MBMS data transmission session independently from the MAC (Medium Access Control) and/or RRC (Radio Resource Control) state of the mobile station.

The current 3GPP (3^{rd} Generation Partnership Project) specification TS 23.246 VO.4.0,titled ‘Multimedia Broadcast/Multicast Service (MBMS); Architecture and Functional Description’ Release 6 (2003-02), defines an MBMS Notification procedure. The MBMS notifications may be defined as messages that may be used to inform the user equipment (UE) about forthcoming, and, potentially, about ongoing, multicast and/or broadcast data transfer. A contribution by Vodafone of the United Kingdom, dated 21 Jan. 2003, for a 3GPP standardization meeting held at San Antonio, Tex., USA, proposes an arrangement wherein the notification is done at the start of the MBMS data transmission by means of group paging, followed by uplink signaling from the mobile station to the network. According to the proposal, during an ongoing MBMS data transmission, the mobile station must always request the MBMS channel allocation information with a Point-to-Point (P-t-P) connection while entering a new cell.

The inventors have found that this proposal, however, may have some disadvantages. For example, operation in accordance with the proposal, in other words, requiring use of paging channels and channel requests, may cause a substantial amount of signaling. The proposal requires much paging capacity and the proposed “group paging” may affect other traffic in the cell, especially during the MBMS notification procedure. Signaling by each mobile station is generally believed to be substantial, especially in the case of the MBMS service, wherein hot spot areas are possible. In such hot spots, the number of mobile station may be tremendous and, hence, the signaling load of the network may also become substantial, and may even exceed the capacity of the communication system.

Another disadvantage of this proposal relates to the requirement of sequential signaling. The proposal assumes uplink signaling for the provision of the network with information regarding the joined mobile stations in a particular cell. However, the inventors have found that it may be advantageous if the system were able to provide the channel allocation parameters for the air interface in the downlink without any uplink signaling, such that the mobile stations could then find the traffic channel on which the MBMS data is transmitted.

Because of the required sequential signaling, the proposal according to the related art may lead to rather long delays in getting the service. This may happen at least in situations where the MBMS service is set up for the first time, or after a cell reselection. In the latter case the service interruption time may become substantially long. The proposal does not provide any means for the mobile station to continue receiving an ongoing MBMS data transfer, for example, after cell reselection, without the requirement for uplink signaling. If the mobile station always has to request the MBMS service while entering a new cell, the mobile station is likely to do so even when outside the MBMS service area, and even if the data transmission has been stopped. This typically adds to the problem of generating high amounts of unnecessary signaling between the mobile station and the base station(s) of the radio access network.

### SUMMARY OF THE INVENTION

Certain embodiments of the present invention aim to address one or several of the above problems.

According to certain embodiments of the present invention, there is provided a method, usually in a communication system, for notifying a station of a wireless data transmission session receivable by a plurality of stations located within a service area. The method commonly includes sending, on at least one broadcasting channel, notifications regarding the wireless data transmission session.

According to other embodiments of the present invention, there is provided a communication system generally configured for transmission of a wireless data transmission session that is usually receivable by stations located within a service area. The system usually includes means for sending, on at least one broadcasting channel, notifications for stations in the service area regarding the wireless data transmission session. According to still other embodiments of the present invention, there is typically provided a message for notifying stations located within a service of a communication system that is normally configured for transmission of a wireless data transmission session, usually receivable by the stations located within the service area. The message commonly is configured for transmission on at least one broadcasting channel and to contain information regarding the wireless data transmission session.

According to certain embodiments, the notifications are broadcast periodically.

The notifications may be broadcast on a broadcast channel of a cellular communication system. For example, a packet broadcast channel of a cellular communication system may be used.

The data transmission session may include a multimedia broadcast service data transmission and/or a multimedia multicast service data transmission.

The content of subsequent notifications may be varied. The content of a notification may be set differently when at least one station has joined the data transmission session in the access entity than for an instance wherein no stations have joined the data transmission session in the access entity. The content of a notification may also be varied in accordance with the on and off state of the data transmission session and/or based on information about the broadcasting channels allocated for the data transmission session.

A notification may be transmitted as an information element included in a system information message, or as a packet system information message, or as a system information message, or a packet system information message.

Certain embodiments of the present invention may provide various advantages. An advantage that may be obtained is that amount of signaling on the air interface may be kept substantially low, and no uplink signaling may be required until the mobile station is able to start the multimedia data reception. Thus, the risk of congestion can be reduced, for example, in the MBMS hot spot areas. In addition, the data interruption time may be shortened from the related art proposals during a cell change. This is generally possible at least since the mobile station usually receives information transmitted on the broadcast channel without a need to monitor a paging channel. MBMS data interruption time can thus be kept substantially short, especially in instances wherein the data transmission is activated on the air interface. This advantage may especially apply after cell reselection.

The joined mobile stations are commonly able to continue the data reception after the cell change in the target cell, typically without any uplink signaling. According to certain embodiments, the only situation wherein the network needs to become aware of a joined mobile station to activate the air interface for the MBMS data transmission may occur when the first mobile station enters a cell in which the MBMS channel is not allocated, in other words, when there is yet no data transmission on air interface.

Embodiments employing repeated notifications may be used, usually to ensure that the mobile station is made aware of the starting and/or ongoing MBMS data transmission without any uplink signaling efforts. By broadcasting the MBMS channel allocation parameters, the frequency hopping may be supported, especially as the related, updated information may be provided in the MBMS notification messages.

### BRIEF DESCRIPTION OF THE DRAWINGS

In order to provide a better understanding of certain embodiments of the present invention, reference will now be made, by way of example, to the accompanying drawings in which:

FIG. 1 shows a representative multimedia communication system;

FIG. 2 shows three cells of a representative radio access network of an exemplary mobile communication system;

FIG. 3 is a flowchart illustrating one embodiment of the present invention;

FIG. 4 is a flowchart illustrating another embodiment of the present invention; and

FIG. 5 shows a message including an information element, typically for carrying a notification in accordance with an embodiment of the present invention.

### DETAILED DESCRIPTION OF THE PREFERRED EMBODIMENT(S)

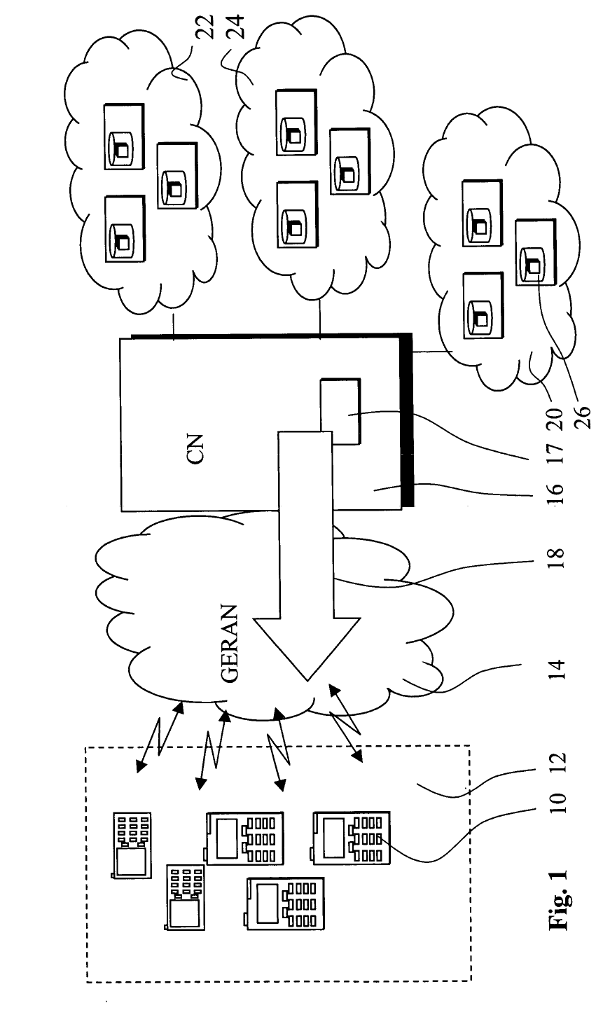

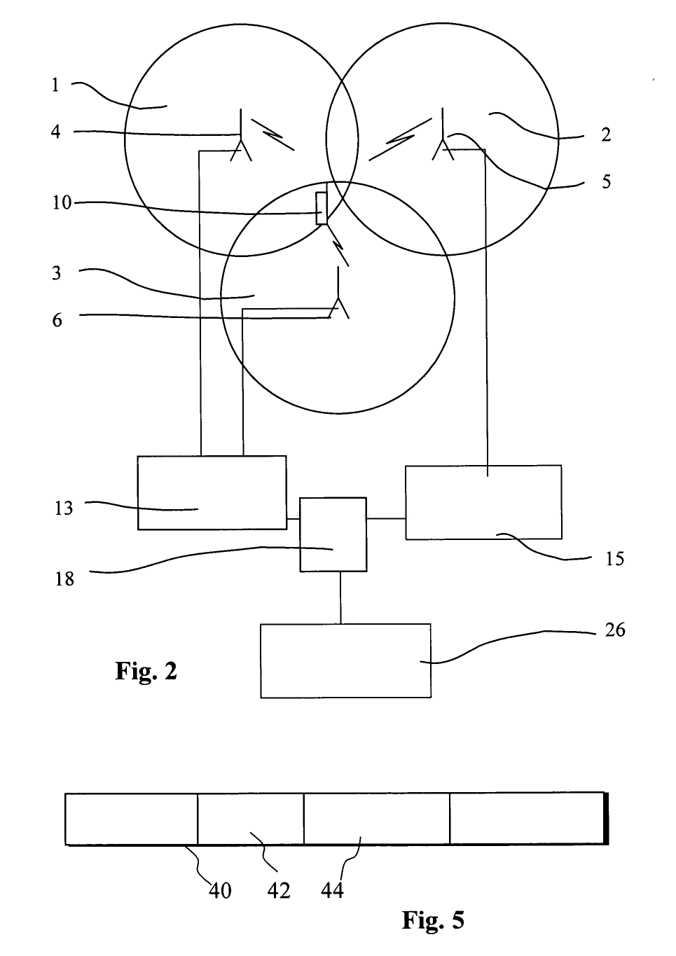

Reference is made to FIG. 1, which shows a communication system architecture wherein the present invention may be embodied. The representative communication system is shown to include a core network (CN) 16 and a radio access network, such as a GSM/EDGE radio access network (GERAN) 14. The exemplary radio access network in FIG. 1 is serving mobile stations 10, as will be explained in more detail below with reference to FIG. 2.

The core network (CN) 16 typically includes various switching elements and/or gateways, usually included for enabling communication via a number of radio access networks and also, commonly, for interfacing the one cellular system with other communication systems, such as with other cellular systems and/or fixed line communication systems. The core network elements may include elements such as, but not limited to, mobile switching centers (MSC) and/or Packet Data Support Nodes (PDSN), and gateways. These do not normally form an essential element of the embodiments of the present invention, and are therefore omitted from the figures and will not be explained in any greater detail.

FIG. 1 shows different service provision environments 20, 22 and 24 that may be connected to the core network 16. The service provision environments may include, for example, operator specific services, Internet hosted services, and/or multimedia services. Each of the representative service provision networks is shown to include service provider entities 26. A service provider entity may include a server and/or similar device that is usually run and/or managed by a service provider. The service provider entity is generally the actual provider of the content to the mobile station. Since the service provider entity does not normally form an essential element of the embodiments of the present invention discussed herein either, it is not described in any more detail. It is sufficient to note that it often forms a possible source of data to be sent to the mobile station, usually via the core network and/or radio access network of the communication system. Such data is shown by means of arrow 18.

Representative mobile stations 10 subscribing to a multicast mode service are shown to be located within a service area 12. The service area may be understood as an area in which a specific broadcast and/or multicast service is available. The service area may be defined individually per service. The service area may represent the coverage area of the entire mobile communication network, or part(s) of the coverage area thereof. The service area is typically the sum of all local service areas offering the same service. For example, in FIG. 2, the service area may be formed by the combination of the three local areas, in other words, cells 1 to 3.

An exemplary broadcasting control entity 17, in this case, arranged for provision of broadcast and/or multicast control at the core network side, is also shown. The broadcasting controller entity may be any appropriate entity generally configured for controlling broadcasting and/or multicasting, usually in a mobile communication system. An example of possible control entities is the Broadcast Multicast Service Center (BM-SC) of the 3GPP. Those interested will find a more detailed description of the BM-SC from the above-referenced 3GPP specification TS 23.246.

Reference is now made to FIG. 2, which includes a simplified presentation of a part of a typical cellular system, more particularly, three access entities or, in other words, cells from the service area 12 of FIG. 1. In the shown arrangement, three base stations 4, 5 and 6 provide three access entities or cells 1 to 3.

Each cell is usually controlled by an appropriate controller. The controller (13 or 15) may be, for example, provided by any appropriate controller. A controller may be provided for each base station and/or a controller may control a plurality of base stations. Solutions wherein controllers are provided in individual base stations and in the radio access network level for controlling a plurality of base stations are also within the scope of certain embodiments of the present invention. Generally, the name, location and/or number of the radio access network controllers depends on the system. For example, a UMTS terrestrial radio access network (UTRAN) may employ a controller node that is commonly referred to as a radio network controller (RNC). In the GSM, CDMA2000 and GPRS systems, a corresponding radio network controller entity is usually referred to as a base station controller (BSC). In this specification, all possible radio network controllers are denoted by the controller elements 13 and 15 of FIG. 2.

It shall be appreciated that the FIG. 2 presentation is highly schematic and that, in practical implementations, the number of base stations and cells could be substantially higher. One cell may, for example, include more than one base station site. A base station apparatus or site may also provide more than one cell. The radio access network may also include only one cell. These features typically depend on the implementation and circumstances.

Each base station 4 to 6 is usually arranged to transmit signals to and/or receive signals from a mobile device 10 of a mobile user via a wireless interface. The mobile user may use any appropriate mobile device adapted for Internet Protocol (IP) communication to connect to the network. For example, the mobile user may access the cellular network by means of a Personal computer (PC), Personal Data Assistant (PDA), mobile station (MS) and so on. The following examples are described in the context of mobile stations.

The person skilled in the art of the present invention is generally familiar with the features and/or operation of a typical mobile station. Thus, these do not need any detailed explanation. It is sufficient to note that the user may use a mobile station 10 for tasks such as, but not limited to, for making and/or receiving phone calls, for receiving and/or sending data from and/or to the network and for experiencing, for example, multimedia content. A mobile station may include an antenna element for wirelessly receiving and/or transmitting signals from and/or to base stations of the mobile communication network. A mobile station 10 may also be provided with a display for displaying images and/or other graphical information for the user of the mobile user equipment. Speaker means are also typically provided. The operation of the mobile user equipment may be controlled by, for example, means of an appropriate user interface such as, but not limited to, control buttons, voice commands and so on. Furthermore, a mobile station is typically provided with a processor entity and/or a memory means.

Each of the mobile stations 10 is usually able to transmit signals to and/or receive signals from the base stations, commonly via the wireless interface. It shall be appreciated that, although, for clarity, only one mobile station 10 is shown in FIG. 2, a number of mobile stations may be in simultaneous communication with each base station.

The mobile station telecommunications networks usually provide mobility for the users thereof. In other words, the mobile station 10 is typically able to move from one cell coverage area to another cell coverage area. The location of the mobile station 10 may thus generally vary in time as the mobile station is free to move from one location, base station coverage area, or cell, to another location, in other words, to another cell, and also within one cell.

The cells in a communication network may be divided in at least two categories in the context of MBMS services. That is, a category where there is at least one joined mobile station in the cell, and a category where there are no joined mobile stations.

In the exemplary embodiments below are described mobile stations that may be notified of a wireless multimedia data transmission session receivable by a plurality of mobile stations. The notification is usually accomplished by sending, on at least one broadcasting channel, notifications regarding the wireless data transmission session. The broadcasting channels are normally transmitted by means of the station apparatus of the radio access network.

The generation, configuration and/or sending of the notifications is typically handled at the radio access network, preferably by entities 13 and 15 controlling the base stations. The controllers of the radio access network notification may be sent and/or configured based on information 18 from the core network.

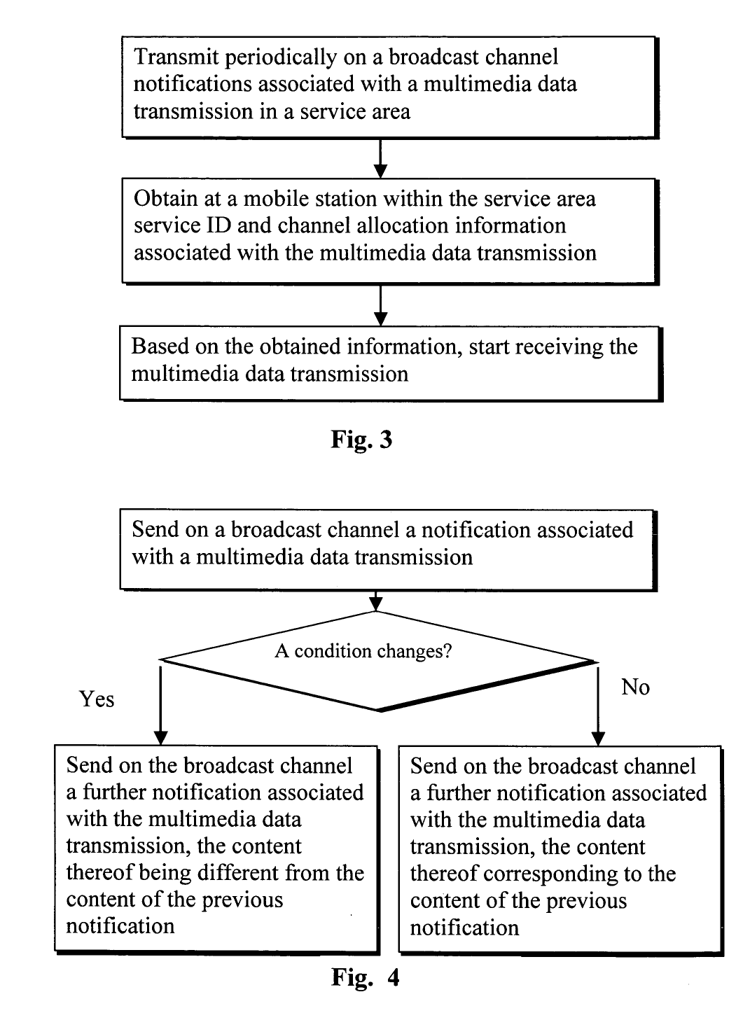

The following describes in more detail an embodiment wherein an indication is given to GPRS enabled mobile stations regarding a Multimedia Broadcast Multicast Services (MBMS) data transmission. The MBMS data transmission may be about to start or may be already on. In some preferred embodiments, existing broadcast channels are commonly used for periodic transmission of MBMS Notification messages. In this regard, a reference is made to FIG. 3.

The indication may be given regardless of the MAC (Medium Access Control) or RRC (Radio Resource Control) state of the mobile station. The following also describes how the mobile station is often able to know that a MBMS data session is going on, even in instances wherein there is no active air interface between the mobile station and the radio access network of the communication system for the transmission of MBMS data.

The content of the notification message may vary, usually depending on the information required. The possibility of sending variable content notifications is shown in FIG. 4. The content may depend on whether the channel resources for transmitting the MBMS data are allocated or not.

Before explaining in more detail a possible mechanism for sending the notifications, a brief description is given regarding possible channels whereon such notifications may be transmitted.

Mobile communication networks typically provide several different, typically unidirectional, control channels. By means of the control channels, the network generally controls the operation of the mobile stations. For example, in the GSM, one of the control channels is commonly provided by means of the broadcast control channel (BCCH). The broadcast control channel typically enables transmission of information on different cells of the communication network.

Typically, the control information to be transmitted on a broadcast channel includes information such as, but not limited to, cell identification information, network identification information, frequencies used in a cell, and so on. Each base transceiver station of the access network typically transmits information in a cell on a broadcast control channel of its own. All mobile stations in the area of the cell then usually listen to that broadcast channel. In the GSM, the broadcast control information is normally sent by using the so-called System Information (SI) messages on the BCCH.

General Packet Radio Service (GPRS) systems are also usually provided with specific control channels. One of these is the so-called packet broadcast control channel (PBCCH). The task of the PBCCH is generally to transmit system information to all GPRS-enabled mobile stations in a cell. Thus, the PBCCH may be seen as a corresponding channel to the BCCH of the GSM.

The MBMS notification message may be broadcast to the mobile station by means of, for example, an appropriate broadcasting channel. As explained above, the Broadcast Channel (BCCH) may be used for the transmission, especially if the Packet Broadcast Channel (PBCCH) is not supported in the cell. If the PBCCH is supported and/or the mobile station is in the Idle mode or in the MAC-Idle state, in other words, in the GERAN Iu mode, then the PBCCH may be used.

The MBMS notification message may be broadcasted before, at the beginning and/or during a MBMS data session. The message may contain information regarding the service ID of the MBMS service. Based on the service ID, the mobile station is typically able to know if the notification applies to the MBMS service to which it has joined.

The mobile station may also obtain, usually from the message, information regarding the MBMS channel allocation. Based on the MBMS channel allocation information, the mobile station is typically able to start to receive the transmitted MBMS data.

In addition to the above, information such as, but not limited to, starting time and other relevant information of the MBMS data transfer may be broadcast to mobile stations within the multimedia service area. The notifications may also contain control information such as, but not limited to, instructions for actions to be performed by the mobile station.

A MBMS notification message may be generated at the start of a MBMS data transmission, usually containing various types of information. The MBMS notification message may include, for example, parameters associated with the Service ID and/or MBMS channel allocation. Based on these parameters, the joined mobile stations may move to listen to the identified MBMS channel. Alternatively, the MBMS notification message may only include the Service ID and not the MBMS channel allocation parameters. This will typically continue until the first such mobile station that has joined the service enters the cell.

MBMS notification messages broadcast during an ongoing MBMS data transmission may include, for example, the Service ID and/or the MBMS channel allocation parameters of the data transmission. A joined mobile station entering the cell may then obtain the MBMS channel allocation parameters, usually by reading the related Packet System Information (PSI) message.

As above, the MBMS notification message may, according to certain embodiments, include only the Service ID and not the MBMS channel allocation parameters. After becoming aware that there is currently a joined mobile station in the cell, the network may then allocate the MBMS channel. The content of the MBMS notification message may be changed, typically to reflect this, usually such that it contains the MBMS channel allocation parameters. As soon as the joined mobile station receives these parameters, it can generally move to the appropriate MBMS channel.

According to an alternative approach, the network often provides the parameters directly using point-to-point (p-t-p) connection to the mobile station. The content of the MBMS notifications is normally changed after this. By means of the p-t-p, the particular mobile station may get the channel allocation information more quickly than via the broadcast channels. However, it may not be advisable to use the p-t-p, especially for a group of mobile stations, because of the commonly present potential risk of congestion.

The content of the MBMS notification messages may also be changed back to not include the MBMS channel allocation parameters. This may be needed, for example, when there are no joined mobile stations any more in the cell and/or the resources for the MBMS channel are released on the air interface.

The variable content notifications may be used, for example, in order to optimize use of the radio resources. The switching of the data transmission on or off may be based on information such as, but not limited to, whether any joined mobile stations are located in a particular cell. As described above, this may impact the content of the notifications.

In certain preferred embodiments, the notification messages are broadcast periodically. By means of the periodic broadcasting, it is generally possible to ensure, usually with an acceptable reliability, that the user equipment in the broadcasting area are informed about forthcoming and about ongoing multicast/broadcast data transfer. It shall generally be appreciated that the length of the period commonly depend on various factors such as, but not limited to, the time of the day, weekday, location of the cell, density of mobile stations in a cell, number of joined mobile stations and so on. The frequency of the transmission may also vary from cell to cell. The frequency may be adjusted adaptively based on, for example, any of the above-referenced factors. According to certain embodiments, MBMS notification messages are not necessarily broadcasted if no MBMS data session is starting/going on, the cell is not belonging to any MBMS service area, and/or the cell is not supporting MBMS. This rule may be used, for example, to ensure that notifications are not sent unnecessarily.

If the data transmission is not activated in the air interface between the mobile station and the base station, the MBMS notification message can typically be broadcasted such that the message does not contain the MBMS channel allocation information, as no radio resources are generally reserved for the data transmission. This may occur, for example, in situations where there are no mobile stations in the cell which have joined that particular MBMS service.

If no MBMS data session is active and/or if an ongoing data session is inactivated, no MBMS notification message necessarily needs to be broadcast. This generally also applies for the case wherein the cell is not supporting the MBMS and/or does not belong to a MBMS service area.

The message notifying the mobile station of the MBMS data transmission session may be in the form of an information element (IE). The following is a representative example of such a MBMS notification information element:

< MBMS Notification struct > ::=
< MBMS Service ID/TGMI : bit (4/???) >
{ 0 | 1 < PFI : bit (7) > }
{ 0 | 1 < RAB ID : bit (8) > }
{ 0 | 1 < RB ID : bit (5) > }
< MBMS TFI Assignment : bit (5) >
< Timeslot Allocation : bit (8) >
< MBMS Data Transmission Starting Time : < Starting Frame Number
Description IE > >
{0|1 < Frequency Parameters : <Frequency Parameters IE > >};

In the above, the ‘MBMS Service ID’ generally describes the MBMS service which is typically going to be broadcast. Since simultaneous reception of more than one MBMS services is usually possible in the MBMS services, several MBMS Service IDs may be included in an information element. MBMS TFI (Temporary Flow Identity) Assignment commonly indicates the certain TFI assigned to the certain MBMS Service ID. Timeslot Allocation field normally indicates the timeslots assigned for use of MBMS data transmission during the TBF (Temporary Block Flow).

The MBMS Data Transmission Starting Time field typically contains a starting time that commonly indicates the time division multiple access (TDMA) frame number during which the assigned TBF may start. If no downlink TBF is in progress, in other words, if there is no MBMS data transmission, the mobile station need not necessarily monitor the TFI field of downlink Radio Link Control (RLC) data blocks, at least until the indicated TDMA frame number. After the indicated TDMA frame number, the mobile station may operate as during a downlink TBF. If a downlink TBF is already in progress, in other words, if there is an active MBMS data transmission, the mobile station may generally continue to use the parameters of the existing TBF, at least until the TDMA frame number occurs. When the indicated TDMA frame number occurs, the mobile station may immediately begin to use the new parameters assigned. The definition of this field may be similar to that of the TBF Starting Time information element defined for the GPRS in the 3GPP TS 44.060.

According to certain embodiments, Frequency Parameters information element may be used to define frequency parameters and/or a training sequence code (TSC), which may, for example, be allocated to a mobile station, usually to define its channel configuration. All timeslots in the channel configuration of the mobile station normally may use the same frequency parameters and/or training sequence code. The definition of this field may be similar to that of the Frequency Parameters information element defined for the GPRS in the above-referenced 3GPP TS 44.060.

The mobile station may, according to certain embodiments, identify the end of the MBMS data transmission, usually based on the broadcast MBMS TFI Assignment parameter. If the value of the TFI on the MBMS data channel is different than the value of MBMS TFI Assignment and/or if the channel is “quiet”, then the mobile station may assume that the MBMS data transmission has been ended. From the service point of view, this is advantageous, at least since this normally allows for the possibility of starting following an already ongoing MBMS data transfer. This may happen, for example, when a mobile station is turned on, such as after a cell reselection.

The new information element may be sent, for example, by using existing SI/PSI (System Information/Packet System Information) messages. This MBMS notification information element may be a new System Information (SI) message or a new Packet System Information (PSI) message. It is also a possibility, according to certain embodiments, to include the information element in an existing message as a new information element, is representatively illustrated in FIG. 5. In FIG. 5, an MBMS notification information element 42 is included in a message 40. As shown, the message 20 may also contain other information elements 44.

Which one of these possibilities is desired may depend on various factors such as, but not limited to, the size of the information element.

It shall be appreciated that if the mobile station is in the Packet Transfer mode or MAC-Shared state, it may, according to certain embodiments and in certain instances, be desired to transmit the MBMS notification information via the PACCH (Packet Associated Control Channel). Whether this option is to be used normally depends on the implementation. It may be desired, for example, that for such mobile stations the control messages are preferably transmitted on the packet associated control channel, especially since this channel is typically an internal control channel, in other words, an in-band channel, of a traffic channel packet data traffic channel (PDTCH). In such a case, the control messages are commonly transmitted among the data packets that form the actual payload on the same physical channel.

According to certain embodiments, it is usually possible to send information associated with a plurality of multimedia services in a single notification on the broadcast channel. A notification message may be broadcast on a plurality of broadcasting channels.

It should be appreciated that, whilst certain embodiments of the present invention have been described in relation to mobile stations, other embodiments of the present invention are applicable to any other suitable type of user equipment.

Certain embodiments of the present invention have been described in the context of a GERAN access network and a GPRS system. However, certain embodiments of this invention, are also applicable to any other access techniques including, but not limited to, code division multiple access, frequency division multiple access and/or space division multiple access, as well as any hybrids thereof, and, generally, to any other communication standard where similar problem may occur and/or advantage is typically obtainable by means of certain embodiments of the invention.

According to certain embodiments, the multimedia data may be multicast or broadcast in any suitable format.

It should also be appreciated that base stations may sometimes be referred to as node B. In addition, the term cell is generally intended to also cover a group of cells, especially in instances where more than one cell is controlled by a controller entity.

It is also noted herein that, while the above describes exemplary embodiments of the present invention, there are several variations, combinations of features and/or modifications which may be made to the disclosed solution without departing from the scope of the present invention, as defined in the appended claims.

We claim:

1. A method in a communication system for notifying a station of a wireless data transmission session receivable by a plurality of stations located within a service area, the method comprising:
sending on at least one broadcasting channel notifications regarding the wireless data transmission session.

2. The method as claimed in claim 1, wherein, in the sending step, the notifications are broadcast periodically.

3. The method as claimed in claim 2, further comprising adjusting the period between the broadcasts.

4. The method as claimed in claim 1, wherein, in the sending step, the notifications are broadcast on a broadcast channel of a cellular communication system.

5. The method as claimed in claim 4, wherein, in the sending step, the notifications are broadcast on a packet broadcast channel.

6. The method as claimed in claim 1, wherein, in the sending step, the data transmission session comprises a multimedia broadcast service data transmission.

7. The method as claimed in claim 1, wherein, in the sending step, the data transmission session comprises a multimedia multicast service data transmission.

8. The method as claimed in claim 7, wherein, in the sending step, the multicast service data transmission is receivable only by stations that are subscribers to the multicast service.

9. The method as claimed claim 1, further comprising:
varying the content of the notifications associated with an access entity of the communication system.

10. The method as claimed in claim 9, wherein, in the varying step, the content of a notification is set differently when at least one station has joined the data transmission session in the access entity than for an instance wherein no stations have joined the data transmission session in the access entity.

11. The method as claimed in claim 9, wherein, in the varying step, the content of a notification is varied in accordance with the on and off state of the data transmission session.

12. The method as claimed in claim 9, wherein, in the varying step, the content of a notification is varied based on information about the traffic channels allocated for the data transmission session.

13. The method as claimed in claim 1, further comprising sending on the broadcasting channel a notification at the beginning of the data transmission session.

14. The method as claimed in claim 1, further comprising sending on the broadcasting channel a notification during the data transmission session.

15. The method as claimed in claim 1, further comprising sending on the broadcasting channel a notification until the end of the data transmission session.

16. The method as claimed claim 1, wherein, in the sending step, the notification comprises information regarding the service identity of a multimedia service the data transmission session associates with.

17. The method as claimed in claim 1, wherein, in the sending step, the notification comprises information regarding the at least one channel allocated for the data transmission session.

18. The method as claimed in claim 1, wherein, in the sending step, the notification comprises information regarding the starting time of the data transmission session.

19. The method as claimed in claim 1, wherein, in the sending step, the notification is transmitted as an information element included in a system information message or a packet system information message.

20. The method as claimed in claim 1, wherein, in the sending step, the notification is transmitted as a system information message or a packet system information message.

21. A communication system configured for transmission of a wireless data transmission session receivable by stations located within a service area, the system comprising:
means for sending on at least one broadcasting channel notifications for a station in the service area regarding the wireless data transmission session.

22. The communication system as claimed in claim 21, wherein the communication system is configured for periodic transmission of the notifications.

23. The communication system as claimed in claim 21, wherein the data transmission session comprises a multimedia broadcast or multicast service data transmission.

24. The communication system as claimed in claim 21, the communication system being configured for varying the content of notifications associated with an access entity of the communication system.

25. The communication system as claimed in claim 21, wherein at least one of the notifications comprises information regarding the service identity of a multimedia service the data transmission session associates with and at least one channel allocated for the data transmission session.

26. The communication system as claimed in claim 21, the communication system being configured for transmitting at least one of the notifications as an information element included in a system information message or a packet system information message or as a system information message or a packet system information message.

27. A message for notifying stations located within a service area of a communication system configured for transmission of a wireless data transmission session receivable by the stations located within the service area, the message comprising being configured for transmission on at least one broadcasting channel and to contain information regarding the wireless data transmission session.

28. The message as claimed in claim 27, wherein the information regards at least one of the following: a service identity of a multimedia service the data transmission session associates; at least one channel allocated for a data transmission session; and a starting time of the data transmission session.

29. The message claimed in claim 27, the message comprising an information element included in a system information message or a packet system information message or being formed as a system information message or a packet system information message.

30. A communication system capable of notifying a station of a wireless data transmission session receivable by a plurality of stations located within a service area, the system comprising:
sending means for sending on at least one broadcasting channel notifications regarding the wireless data transmission session.

31. A communication system configured for transmission of a wireless data transmission session receivable by stations located within a service area, the system comprising:
a network for sending on at least one broadcasting channel notifications for a station in the service area regarding the wireless data transmission session.

32. A communication system for forwarding a message for notifying stations located within a service area of the communication system configured for transmission of a wireless data transmission session receivable by the stations located within the service area, the system comprising:
configuration means for configuring the message for transmission on at least one broadcasting channel and to contain information regarding the wireless data transmission session.
